(19) United States
(12) Patent Application Publication
(10) Pub. No.: US 2025/0121525 A1
(43) Pub. Date: Apr. 17, 2025

(54) ROTARY KNIFE BLADE WITH SEGMENTED RACE

(71) Applicant: Hantover, Inc., Overland Park, KS (US)

(72) Inventors: Ronald J. Curnett, Cross Timbers, MO (US); Craig E. Feeler, Independence, MO (US)

(73) Assignee: Hantover, Inc., Overland Park, KS (US)

(21) Appl. No.: 18/913,447

(22) Filed: Oct. 11, 2024

Related U.S. Application Data
(60) Provisional application No. 63/589,517, filed on Oct. 11, 2023.

(51) Int. Cl. B26D 7/26; B26B 25/00; B26D 1/143

(52) U.S. Cl. CPC B26D 7/2621; B26B 25/002; B26D 1/143

(57) ABSTRACT

A rotary knife includes a blade housing and an annular blade. The blade housing includes a housing race. The annular blade includes a blade race. One of the housing race and the blade race defines a wear band. The other of the housing race and the blade race defines an annular groove. The annular groove receives the wear band such that the annular blade is rotatably supported by the blade housing. The wear band has an annular surface. The wear band includes a plurality of surface features formed in the annular surface.

### CROSS REFERENCE TO RELATED APPLICATIONS

This application claims priority benefit of U.S. Provisional Patent Application No. 63/589,517 filed Oct. 11, 2023, and titled ROTARY KNIFE BLADE WITH SEGMENTED RACE. The foregoing application is hereby incorporated by reference in its entirety.

### FIELD OF THE INVENTION

The present invention relates to powered knives, such as those commonly used in slaughterhouses for meat processing. More specifically, the present invention concerns a rotary knife with a rotating annular blade having a segmented wear band for supporting the blade.

### BACKGROUND OF THE INVENTION

Rotary knives are commonly used in meat processing to dress an animal carcass. The process of dressing the carcass normally involves the removal of meat and fat from various bones as well as cutting bones and other carcass material. Rotary knives are configured to process the animal carcass with great efficiency. Conventional rotary knives include a housing and an endless rotating blade. Although rotary knives are efficient at cutting through carcass material, severed carcass debris can accumulate between the annular blade and the blade housing. Such material can discolor and/or burn due to the heat generated between the rotating annular blade and the stationary housing. This can cause the material to stick to the annular blade, thereby causing vibration of the blade. Furthermore, the material increases the amount of torque required to rotate the blade. Yet further, discolored material can cause the processed meat to be unsightly and, in some instances, fail inspection.

### SUMMARY OF THE INVENTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a rotary knife is provided. The rotary knife includes a blade housing having a housing race and an annular blade having a blade race. One of the housing race and the blade race defines a wear band. The other of the housing race and the blade race defines an annular groove. The annular groove receives the wear band such that the annular blade is rotatably supported by the blade housing. The wear band has an annular surface. The wear band includes a plurality of surface features formed in the annular surface.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a top perspective view of a rotary knife head assembly, in accordance with a preferred embodiment of the present invention;

FIG. 2 is a bottom perspective view of the rotary knife head assembly shown in FIG. 1;

FIG. 3 is a sectional view of a portion of the rotary knife head assembly shown in FIG. 1, taken along line 3-3 of FIG. 1;

FIG. 4 is a perspective view of the annular blade used in the rotary knife head assembly of FIG. 1;

FIG. 5 is a top view of the annular blade shown in FIG. 4;

FIG. 6 is a sectional view of the annular blade, taken along line 6-6 of FIG. 5;

FIG. 7 is an enlarged view of a portion of the annular blade shown in FIG. 4;

FIG. 8 is a top perspective view of the blade housing used in the rotary knife head assembly of FIG. 1;

FIG. 9 is a bottom view of the blade housing shown in FIG. 8;

FIG. 10 is an enlarged view of a portion of the blade housing shown in FIG. 8;

FIG. 11 is an enlarged bottom perspective view of the blade housing shown in FIG. 8, depicting a channel extending from a mounting boss to the housing race;

FIG. 12 is an enlarged view of a portion of the annular blade shown in FIG. 4, depicting an alternative arrangement of surface features of the annular blade; and

FIG. 13 is a top perspective view of an alternative rotary knife head assembly, depicting an alternative method of mounting a grease cup assembly.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

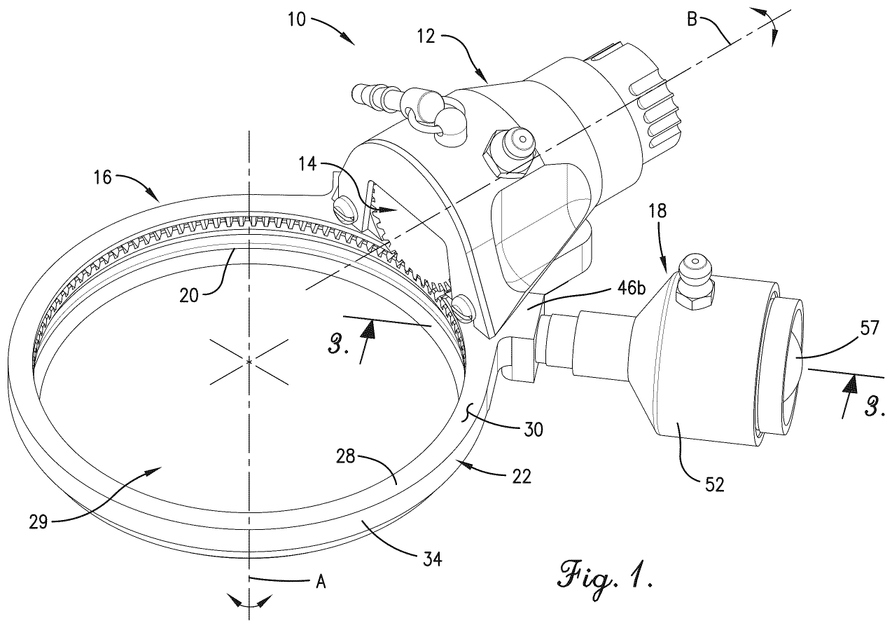

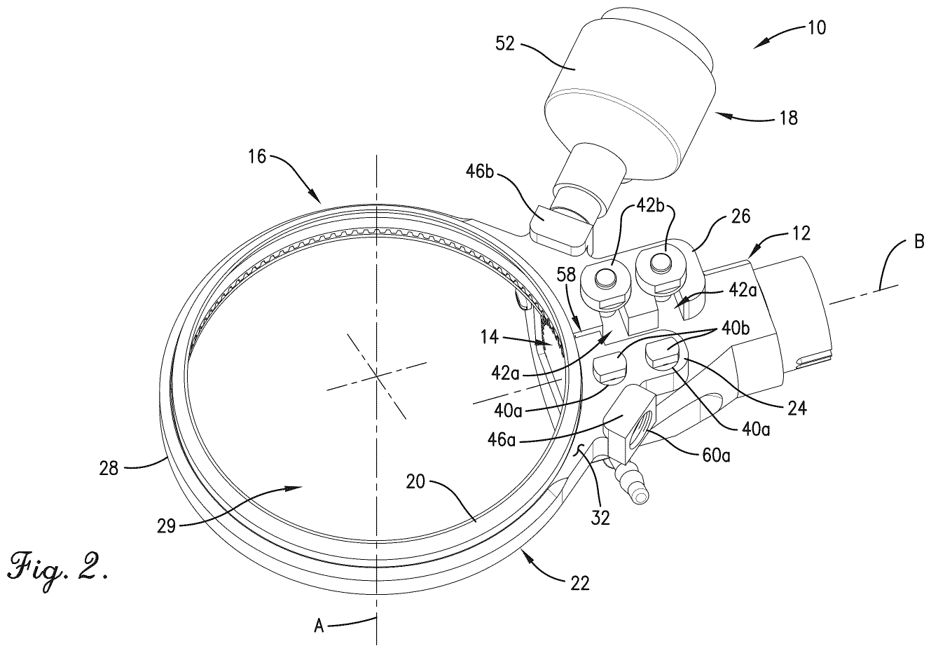

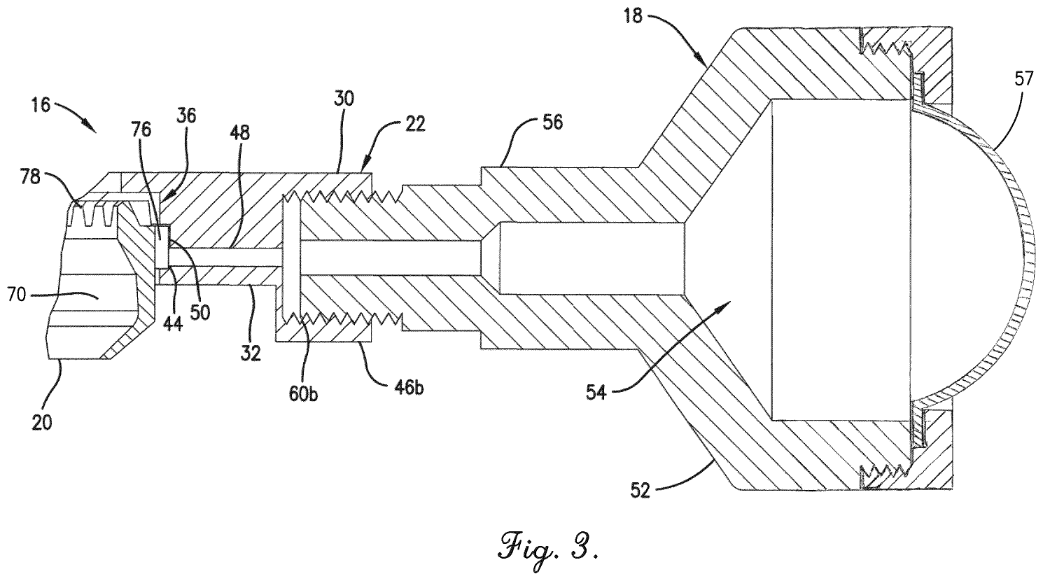

FIG. 1 is a top perspective view of a rotary knife head assembly 10, in accordance with a preferred embodiment of the present invention. FIG. 2 is a bottom perspective view of the rotary knife head assembly 10. FIG. 3 is a sectional view of a portion of the rotary knife head assembly 10, taken along line 3-3 shown in FIG. 1. In the example embodiment, the rotary knife head assembly 10 is particularly suited for use in meat processing operations, for example, to dress an animal carcass, although other knife applications are within the ambit of the present invention.

The rotary knife head assembly 10 is preferably configured for connection to a knife handle or body (not shown), to cooperatively form a rotary knife. The knife handle facilitates manual operation of the rotary knife. In some aspects of the present invention, the rotary knife head assembly 10 may be configured for use in other applications, such as being configured for connection to a robotic arm in which a knife handle is not required.

The rotary knife head assembly 10 is preferably pneumatically powered, for example, by a pressurized air power source (not shown). For example, the knife handle may be configured to house a pneumatic motor for providing power to the rotary knife head assembly 10. The principles of the present invention, however, are correspondingly applicable to embodiments where the rotary knife head assembly is alternatively powered by other power sources, such as hydraulic power sources, electrical power sources, or any other power source that enables the rotary knife head assembly to function as described herein. The other power sources may or may not be housed in the knife handle.

In the exemplary embodiment, the rotary knife head assembly 10 broadly includes a knife head 12, a blade assembly 16, and at least one grease cup assembly 18. The knife head 12 supports a rotatable drive pinion or pinion gear 14 configured to rotate an annular blade 20 of the blade assembly 16, for example, about a rotation axis “A.”

In the example embodiment, the pinion gear 14 is preferably driven by the power source via a drive shaft (not shown) operably mounted in the knife handle or body. As described herein, the pinion gear 14 is rotatably mounted in the knife head 12 and is drivingly intermeshed (i.e., coupled in driving engagement) with the annular blade 20. The pinion gear 14 rotates about a drive axis “B.”

The illustrated knife head 12 is operable to support the blade assembly 16 and to be connected to the knife handle or body (not shown). As described above, the knife head 12 receives and rotatably supports the pinion gear 14, and in some embodiments, a corresponding end of the drive shaft (not shown) for rotation about the drive axis “B.” The blade assembly 16 preferably includes a blade housing 22 releasably coupled to the knife head 12.

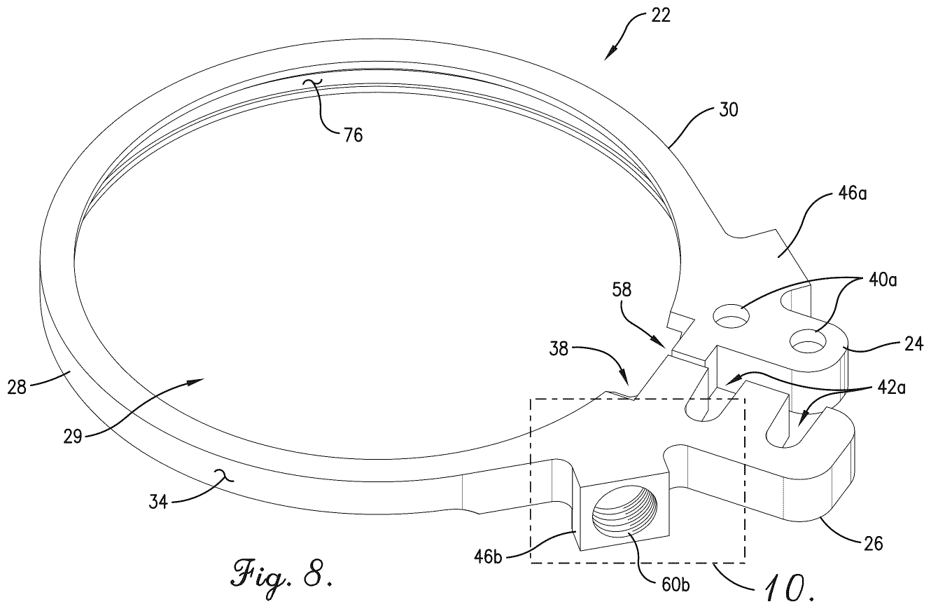

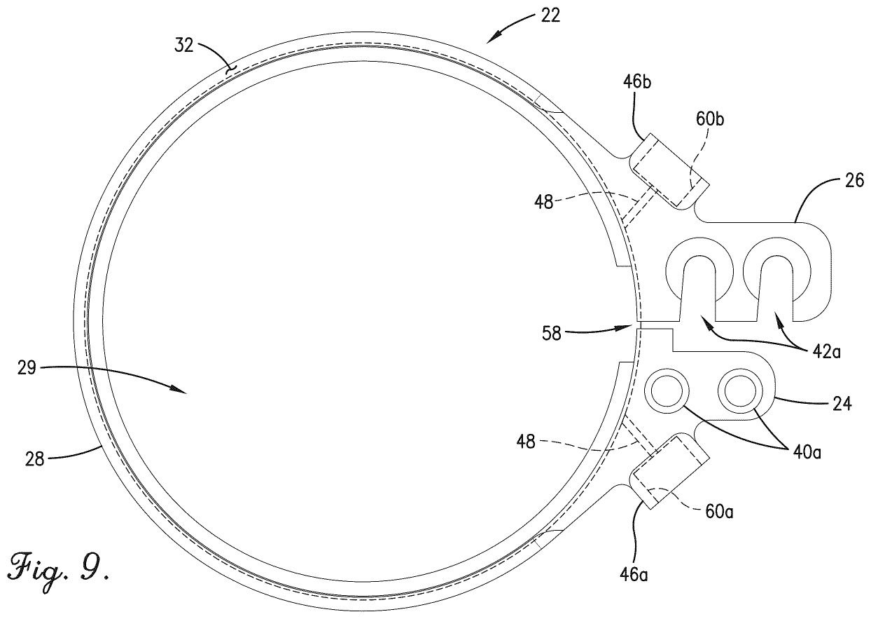

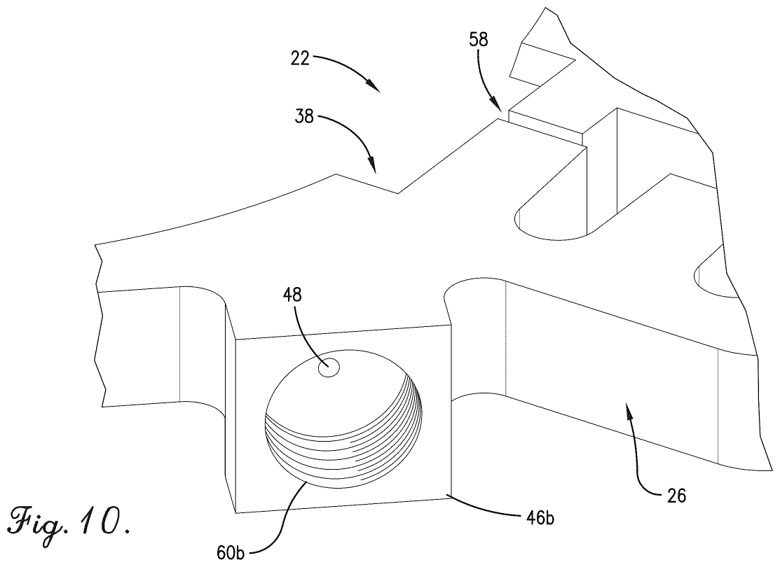

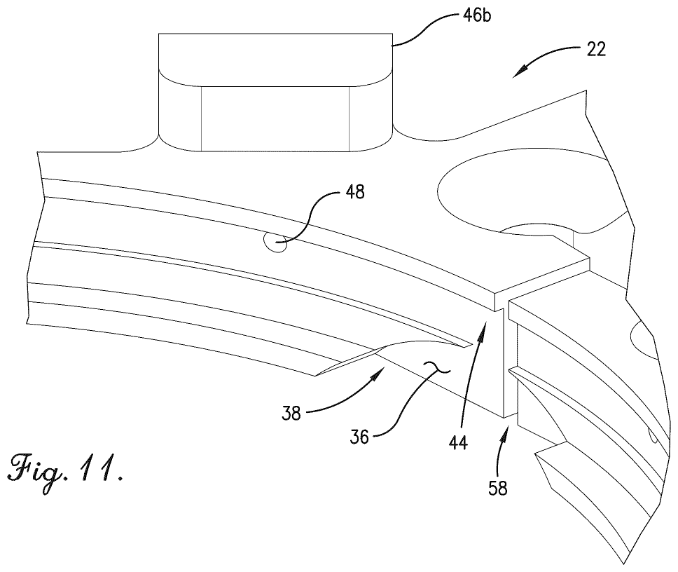

In the exemplary embodiment, the blade housing 22 preferably supports the annular blade 20 during operation and allows blade rotation. The blade housing 22 preferably includes a unitary split ring body that presents adjacent ring ends 24, 26 (see FIGS. 2 and 8-11). A housing gap 58 is defined between the ring ends 24, 26 (see FIGS. 2 and 8-11). The split ring body also includes an annular portion 28. The annular portion 28 preferably extends continuously between the ring ends 24, 26 to present a generally circular ring opening 29. The ring opening 29 is sized to receive the annular blade 20. The blade housing 22 presents opposite sides 30, 32, a curved outer surface 34, and a curved inner surface 36. The ring ends 24, 26 cooperatively present an arcuate relief 38. The arcuate relief 38 is configured to receive a portion of the pinion gear 14.

In the exemplary embodiment, the ring end 24 includes apertures 40a. The apertures 40a are configured to receive corresponding fasteners 40b, which secure the ring end 24 to the knife head 12. The ring end 26 includes slots 42a. The slots 42a are configured to slidably receive bolts 42b coupled to the knife head 12. When mounted on the knife head 12, the split ring body is positionable between a blade-securing position and a blade-releasing position. In the blade-securing position, the blade housing 22 rotatably supports the annular blade 20. In the blade-releasing position, the blade housing 22 allows installation and removal of the annular blade 20. More particularly, when the bolts 42b are loosened, the blade housing 22 may be shifted from the blade-securing position to the blade-releasing position by shifting the ring end 26 away from the ring end 24, thereby expanding the housing gap 58. When the ring end 26 is shifted away from the ring end 24, the split ring body (i.e., the annular portion 28) flexes and the ring opening 29 is enlarged. In the blade-releasing position, the enlarged ring opening 29 allows the annular blade 20 to be inserted and removed relative to the blade housing 22.

In the example embodiment, the inner surface 36 of the blade housing 22 defines a housing race or groove 44 (see FIG. 3). The groove 44 provides a race for supporting the annular blade 20. The groove 44 extends substantially along the entirety of the inner surface 36 of the annular portion 28, between the ring end 24 and the ring end 26. While the illustrated groove 44 is depicted to include a rectangular cross-sectional profile, it is consistent with the principles of the present invention for the groove 44 to include any other alternative cross-sectional profile that enables the blade housing 22 to function as described herein, such as arcuate, semi-circular, trapezoidal, etc. As described herein, the groove 44 is sized and shaped to receive a portion of the annular blade 20, define a suitable operating clearance, and limit axial movement of the annular blade. In an embodiment, the suitable operating clearance may include a loose interference so that sliding support is provided for the annular blade 20.

In the depicted example, the blade housing 22 includes mounting bosses 46a, 46b. In the example embodiment, the mounting boss 46a is formed proximate the ring end 24, and the mounting boss 46b is formed proximate the ring end 26. The mounting bosses 46a, 46b provide mounting structure for attaching the grease cup assembly 18 to the blade housing 22. The mounting structure includes threaded counterbores (also referred to as inlet bores), such as threaded counterbores 60a, 60b, respectively, defined in the mounting bosses 46a, 46b, respectively. The threaded counterbores 60a, 60b are configured to couple to a grease cup assembly, such as the grease cup assembly 18.

The blade housing 22 includes respective lubricant channels 48 extending through each respective counterbore 60a, 60b to the groove 44. In the example, each lubricant channel 48 is an open cylindrical tube, generally formed coaxial with the respective counterbore 60a, 60b. The lubricant channel(s) 48 facilitate channeling a lubricant from the grease cup assembly 18 to the groove 44.

Referring to FIG. 1, the grease cup assembly 18 is shown being coupled to the mounting boss 46b. It is noted, however, that a grease cup assembly 18 may be alternately coupled to the opposite mounting boss 46a. This allows the grease cup assembly 18 to be positioned on either side of the knife head 12. The alternate mounting positions allow a user to selectively mount the grease cup assembly 18 for convenience based on the user's preference and/or handedness. In some embodiments, when only a single grease cup assembly 18 is mounted to the blade housing 22, a plug (not shown) is preferably coupled to the other counterbore 60a or 60b to facilitate reducing entry of contaminants therein. Furthermore, in some embodiments, the blade housing 22 could also include two (2) grease cup assemblies 18, each coupled to a respective one of the mounting bosses 46a, 46b.

Referring to FIG. 3, the grease cup assembly 18 provides a source of lubrication that is channeled to the groove 44 via the lubricant channel 48. More particularly, the lubricant channel 48 facilitates channeling a lubricant from the grease cup assembly 18 to a lubrication interface zone 50 defined between the annular blade 20 and the blade housing 22, as described in detail below.

The grease cup assembly 18 includes a grease cup 52 and a flexible membrane 57 cooperatively defining a lubricant chamber 54, which is preferably filled with a white food-grade lubricant (not shown). The grease cup assembly 18 further includes a mounting shaft portion 56. In the depicted embodiment, the mounting shaft portion 56 is selectively received in one of the threaded counterbores 60a, 60b, defined in the mounting bosses 46a, 46b, respectively. It is noted, however, that other connection methods for attaching the grease cup assembly 18 to the blade housing 22 are entirely within the ambit of the present invention, such as a quick connection coupling, a friction fit connection, a latched connection, and the like. Further, alternative lubricants are permissible according to certain aspects of the present invention.

When the flexible membrane 57 of the grease cup assembly 18 is pressed, the flexible membrane 57 deflects inwardly toward the lubricant chamber 54. The lubricant is channeled (i.e., pushed) from the lubricant chamber 54 and through the mounting shaft portion 56. The lubricant passes through the mounting shaft portion 56 to the lubrication interface zone 50 (via the channel 48 defined in the blade housing 22 in the illustrated embodiment). More particularly, in the preferred embodiment, the lubricant passes through the channel 48 and is routed to the lubrication interface zone 50, thereby providing lubrication to the annular blade 20.

While the grease cup assembly 18 is depicted herein with a flexible membrane for discharging the lubricant from the lubricant chamber, other methods for expelling the lubricant from the lubricant chamber are entirely within the ambit of the present invention. For example, the grease cup assembly 18 may utilize a piston/cylinder arrangement, compressed air, etc. in place of the membrane.

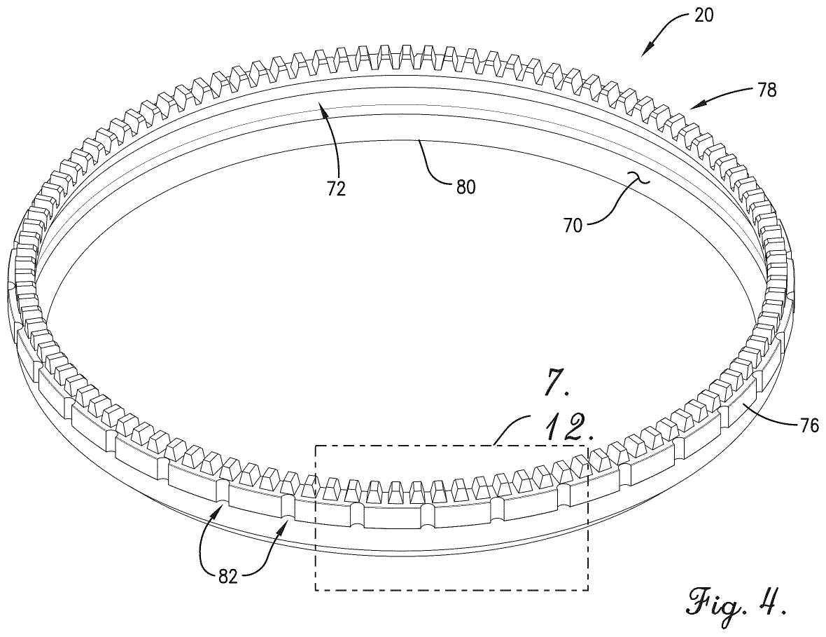

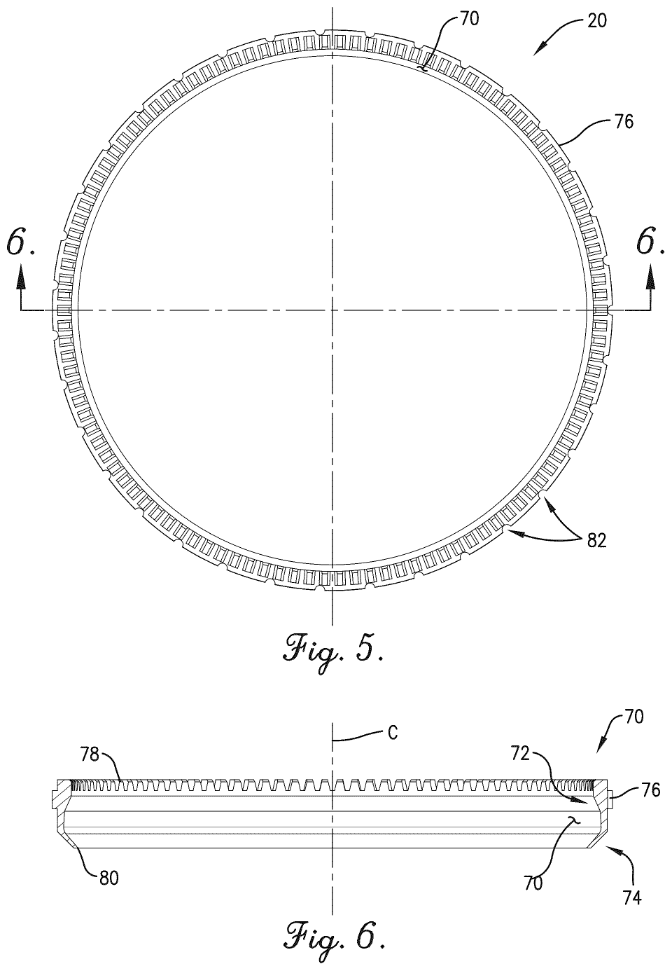

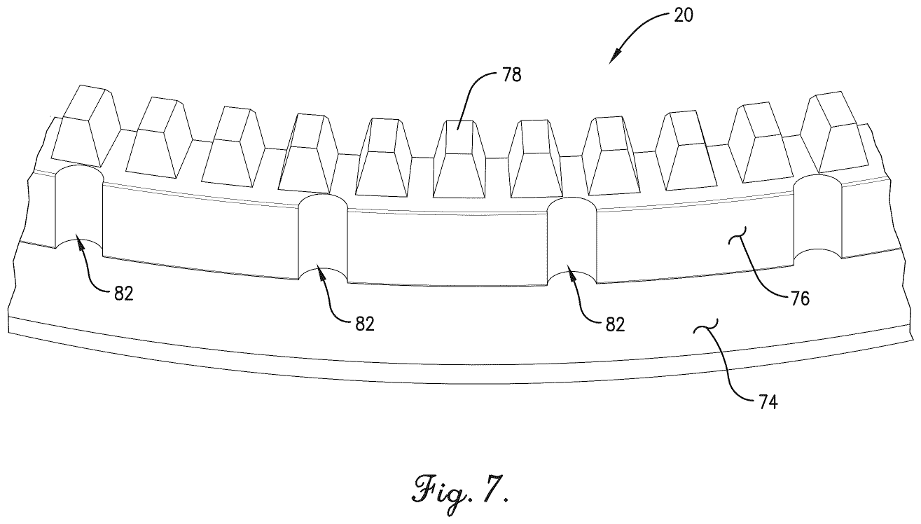

Turning to FIGS. 4-7, the annular blade 20 is unitary and is substantially continuous around its circumference. The annular blade 20 includes a blade wall 70 with a support section 72 and a cutting section 74. The blade wall 70 is substantially circular, defining a central axis “C.” The central axis “C” is preferably colinear with the rotation axis “A,” when the annular blade 20 is mounted to the rotary knife head assembly 10. That is, when assembled, the illustrated blade wall 70 is concentric about the rotation axis “A.”

The support section 72 includes a segmented outer blade race or wear band 76. The wear band 76 includes a substantially rectangular cross-section. While the illustrated wear band 76 is depicted to include a rectangular cross-sectional profile, it is consistent with the principles of the present invention for the wear band 76 to include any other alternative cross-sectional profile that enables the wear band 76 to function as described herein, such as arcuate, semi-circular, trapezoidal, etc. In the example embodiment, the wear band 76 has a cross-sectional profile that is complementary of the cross-sectional profile of the groove 44.

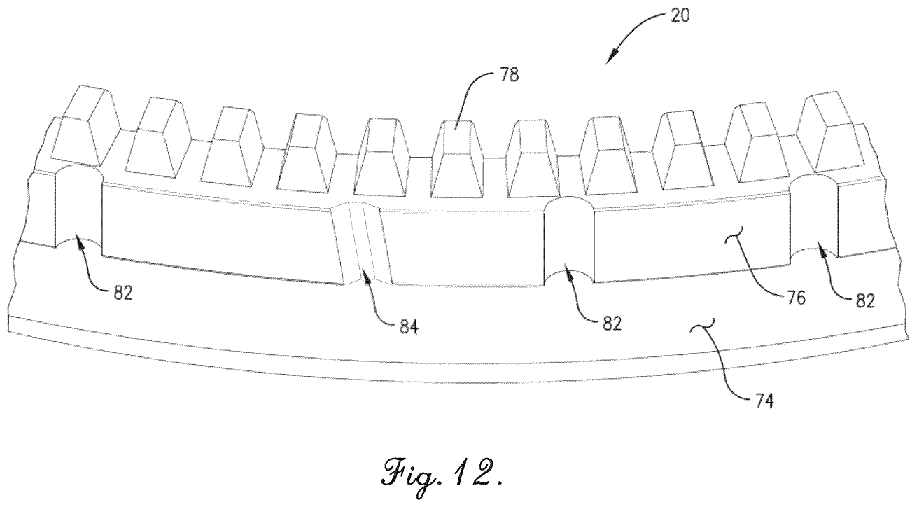

In the example embodiment, the wear band 76 includes a plurality of surface features 82 formed on the outer surface of wear band 76. The surface features 82 are illustratively, at least in part, axially extending grooves or notches that are circumferentially equispaced about the outer surface of the wear band 76. Alternatively, in certain aspects of the present invention, the surface features 82 may be circumferentially spaced in any manner (e.g., other than equispaced) that enables the blade assembly 16 to function as described herein. For example, in an alternative example shown in FIG. 12, the circumferential spacing between a surface feature 84 and at least one of the adjacent the surface features 82 is different than the spacing between each pair of adjacent surface features 82.

In the exemplary embodiment, each of the grooves or notches extend axially relative to the central axis “C.” That is, each surface feature 82 defines a longitudinal axis that is substantially parallel to the central axis “C.” Alternatively, in certain aspects of the present invention, the surface features (i.e., notches or grooves) may extend at an angle relative to the central axis “C.” For example, in FIG. 12, the surface features 82 may extend axially while the surface feature 84 may extend at an angle relative to the central axis “C.” The angle between a longitudinal axis of the surface features and the central axis “C” may be in a range between and including zero degrees (0°) and fifty degrees (50°), wherein the longitudinal axis of the surface features may tilt either forward or backward relative to the central axis “C,” and the direction of rotation. That is, the angle of the surface features may tilt in the direction of rotation of the annular blade 20 or in the direction of counter-rotation of the annular blade 20.

Each groove is preferably arcuate in cross-sectional shape, although alternative groove shapes (such as polygonal, oblong, asymmetrical, etc.) are within the scope of certain aspects of the present invention. Additionally or alternatively, in certain aspects of the present invention, the plurality of surface features may include varying shapes. For example, surface features may have different groove shapes (i.e., not being similarly shaped). Further, alternative groove shapes may repeat in a pattern about the circumference of the annular blade 20. Furthermore, it is noted that the edges defined at the intersection of the surface features and the outer surface of wear band 76 may be tapered or rounded to facilitate reducing or eliminating a sharp edge.

Each of the surface features 82 preferably extends axially through the entirety of the width of the wear band 76. In addition, the illustrated surface features 82 preferably extend radially inward a depth equal to the radial dimension of the wear band 76. That is, the surface features 82 extend radially inward from the outer surface of wear band 76 to the blade wall 70. Alternatively, the surface features 82 may extend radially inward a different depth. It is noted that in certain aspects, all the surface features 82 may extend radially inward at a desired depth, or each of the surface features may extend radially inward at a depth different than one or more of the other surface features. For example, in the alternative example shown in FIG. 12, the surface features 82 may extend radially inward a depth equal to the radial dimension of the wear band 76 while the surface feature 84 may extend radially inward a depth less than the radial dimension of the wear band 76. Further, alternative radial depth dimensions of the surface features may repeat in a pattern about the circumference of the annular blade 20.

In the example embodiment, the annular blade 20 includes thirty-six (36) surface features 82, although it is consistent with the principles of the present invention for the wear band 76 to include fewer or more surface features 82. The surface features 82 facilitate distributing the lubricant about the groove 44, thereby facilitating lubrication of the annular blade/blade housing interface.

It is noted that, while the illustrated embodiment includes the groove 44 defined in the blade housing 22 and the wear band 76 as part of the annular blade 20, certain aspects of the present invention encompass reverse interface orientations, where the annular blade presents an outer annular groove and the blade housing presents a radially projecting lip.

In the exemplary embodiment, the annular blade 20 further includes a ring gear 78 extending from the support section 72. The ring gear 78 is configured for intermeshing with the pinion gear 14. In the example, the ring gear 78 preferably includes about one hundred and ten (110) gear teeth and has a diameter of between about three (3) to four (4) inches. It is noted, however, that other diameters and numbers of gear teeth are entirely within the ambit of the present invention.

The cutting section 74 extends axially from the support section 72 opposite the ring gear 78. The cutting section 74 includes a sharpened cutting edge 80 spaced axially from the ring gear 78. The cutting section 74 also preferably extends radially inwardly from the support section 72. If desired, the annular blade 20 may be alternatively configured to include other types of edges. For example, instead of the sharpened cutting edge 80, the annular blade 20 may alternatively include an abrasive edge (e.g., with a surface that is gritted), a bristled edge, a brush-type shredding edge, etc. Further, the cutting edge may alternatively extend radially outward from the support section.

In the exemplary embodiment, each of the blade housing 22, the pinion gear 14, and the annular blade 20 are preferably manufactured from a tempered steel to resist oxidation and corrosion within the adverse environment of meat processing operations. The principles of the present invention, however, are equally applicable where the blade housing 22, the pinion gear 14, and the annular blade 20 include other metallic or non-metallic materials such as brass, composite, aluminum, or stainless steel. The blade housing 22, the pinion gear 14, and the annular blade 20, either entirely or partly, may alternatively include an outermost layer of brass, composite, aluminum, or stainless steel that is suitable for surface-to-surface engagement. In this manner, such an outermost layer, whether coated, adhered, or otherwise secured onto the base material, may provide an optimal surface for low friction bearing engagement between the various components. However, the outermost layer may be included for other purposes, such as corrosion resistance, aesthetic qualities, or other performance requirements.

In the example embodiment, each of the blade housing 22, the pinion gear 14, and the annular blade 20 are hardened by induction hardening, for example, or the like. In some embodiments, the outer peripheral surfaces are polished after the hardening process. Generally, induction hardening includes a heat treatment process used to selectively harden the surface of the blade housing 22, the pinion gear 14, and the annular blade 20 while maintaining a softer core. This facilitates improving the wear resistance and durability of the components, such as the intermeshed gear teeth and the interfering surfaces of the annular blade 20 and the blade housing 22 (i.e., the curved inner surface 36 and the surfaces of the groove 44). In the example embodiment, the blade housing 22, the pinion gear 14, and the annular blade 20 may be hardened to a Rockwell C hardness in a range between and including about fifty-two (52) and fifty-six (56). In the example embodiment, the Rockwell C hardness is preferably fifty-four (54). When the Rockwell C hardness is less than fifty-two (52), the wear resistance of the blade housing 22, the pinion gear 14, and the annular blade 20 deteriorates. On the other hand, when the Rockwell C hardness is more than fifty-six (56), crack propagation susceptibility, for example, when a minute crack is generated, increases. When the Rockwell C hardness is between fifty-two (52) and fifty-six (56), excellent wear resistance can be achieved.

Additionally, in an example embodiment, each of the blade housing 22, the pinion gear 14, and the annular blade 20 are plated to facilitate reducing friction between the various components. Plating (hard chrome plating, thin dense chrome plating, or the like) is performed at least on the outer surfaces of the annular blade 20 and the inner surfaces of the blade housing 22 (i.e., the curved inner surface 36 and the surfaces of the groove 44) so that the annular blade 20 has durability against friction between the blade housing 22 and itself. Similarly, the teeth of the ring gear 78 and the pinion gear 14 may be plated (chrome plating or the like) so that the ring gear 76 has durability against friction between the pinion gear 14 and itself.

Turning to FIGS. 1-3, when the wear band 76 is received within the groove 44, the outer surface of the wear band 76 is spaced from the inner surface of the groove to define the lubrication interface zone 50. For example, as described above, a suitable operating clearance is defined between the groove 44 and the wear band 76, which may include a loose interference so that sliding support is provided for the annular blade 20.

Prior to assembling the annular blade 20 with the blade housing 22, the blade housing 22 is shifted from the blade-securing position to the blade-releasing position to allow insertion of the annular blade 20. As discussed, the ring end 26 is urged away from the ring end 24 to expand the housing gap 58 and enlarge the opening 29. In the illustrated embodiment, the annular blade 20 is assembled onto the blade housing 22 by inserting the wear band 76 into the groove 44. After the wear band 76 is received within the groove 44, the ring end 26 is released to move toward the ring end 24, which decreases the housing gap 58 and shrinks the opening 29.

After the annular blade 20 is installed, the annular blade 20 is operable to rotate about the rotation axis “A” (see FIG. 1). The pinion gear 14 is preferably mounted in driving intermeshing engagement with the ring gear 78 of the annular blade 20 and rotates about the drive axis “B.” Thus, as the pinion gear 14 rotates about the drive axis “B,” rotation of the pinion gear 14 imparts rotation to the annular blade 20, which rotates about the rotation axis “A.” In the illustrated embodiment, the rotation axis “A” is generally perpendicular to the drive axis “B,” although the rotary knife head assembly 10 could be alternatively configured so that the axes “A,” “B,” define an alternative angular arrangement.

Referring to FIG. 3, the channel 48 defines a pathway to carry a lubricant directly from the grease cup assembly 18 to the lubrication interface zone 50. As described herein, the lubrication interface zone 50 is defined between the annular blade 20 (i.e., the wear band 76) and the groove 44 for receiving the lubricant to reduce friction and thereby reduce heat generated in the lubrication interface zone 50. During use, power is supplied to the rotary knife head assembly 10, which causes the pinion gear 14 to rotate. The driving inter-engagement between the pinion gear 14 and the ring gear 78 of the annular blade 20 causes the annular blade 20 to rotate about the rotation axis “A.” The rotary knife may be manipulated (preferably manually) to move the annular blade 20 through carcass tissue (not shown). A user of the rotary knife may inject lubricant directly into the groove 44 of the blade housing 22. Because the lubricant is injected into the lubrication interface zone 50 by the channel 48, the surface features 82 formed on the outer surface of wear band 76 facilitate distributing the lubricant about the circumference of the groove 44 and the annular blade 20. That is, each of the surface features 82 receive a portion of the lubricant and carry it around the groove 44 when the annular blade is rotating about the rotation axis “A.”

As the annular blade 20 rotates in the blade housing 22, heat may be generated due to friction between the rotating blade and stationary housing. During use in meat processing operations, various carcass debris (e.g., fragments of meat, fat, bones, etc.) may move into the lubrication interface zone 50. The heat generated between the blade and housing can burn the debris. In the example embodiment, the lubricant facilitates reducing the heat, thereby mitigating the burning of the carcass debris. Moreover, the segmented wear band 76 (and particularly the open spaces provided by the surface features 82) facilitate moving the lubricant and carcass debris around the groove 44 to the housing gap 58. The carcass debris and excess lubricant may be deposited into the housing gap 58, where it may be ejected from the rotary knife. In some cases, with the use of the surface features 82, the lubricant (and therefore, the grease cup assembly 18) may be eliminated altogether.

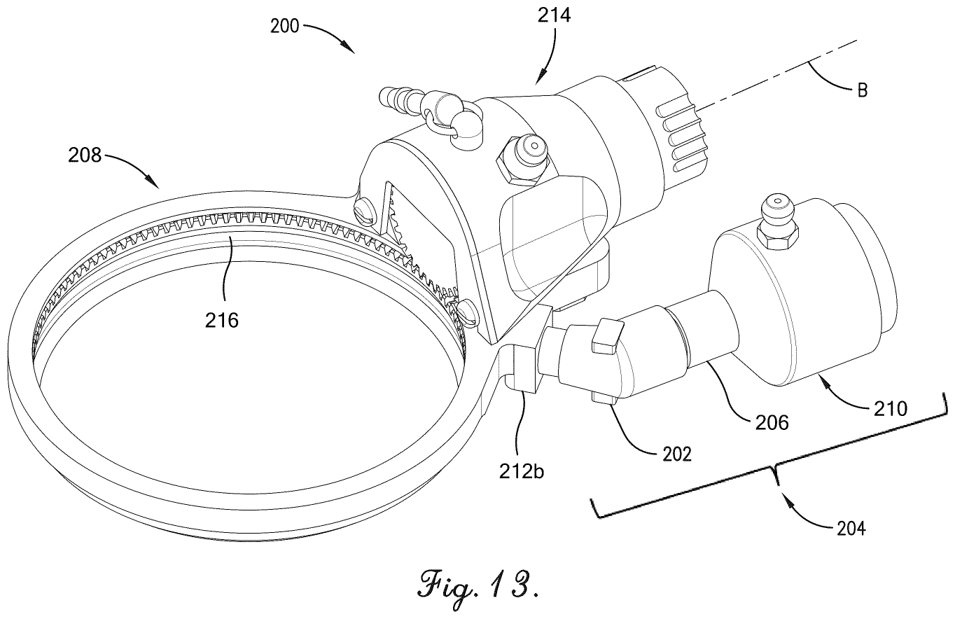

FIG. 13 is a top perspective view of an alternative rotary knife head assembly 200, depicting an alternative grease cup assembly 204. In the embodiment depicted in FIG. 13, the components of the rotary knife head assembly 200 other than the alternative grease cup assembly 204 are substantially the same as the rotary knife head assembly 10 depicted in FIGS. 1-3. The grease cup assembly 204 includes a mounting elbow 202 in addition to the other components and features of the grease cup assembly 18 depicted in FIGS. 1-3. The mounting elbow 202 is attached to the mounting shaft portion 206, such that the mounting elbow 202 is mounted between the blade housing 208 and the grease cup 210. In the example, the grease cup assembly 204 is shown being coupled to a mounting boss 212b. It is noted, however, that the grease cup assembly 204 may be alternately or additionally coupled to an opposite mounting boss (not visible in FIG. 13). As shown in FIG. 13, the mounting elbow 202 is shaped to align a longitudinal axis of the grease cup assembly 204 generally parallel to the drive axis “B.” This allows the grease cup assembly 204 to be positioned on either side of the knife head 214 and generally aligned with a knife handle or body (not shown). Aligning the grease cup assembly 204 with the knife handle or body facilitates positioning the grease cup assembly 204 close to the handle so the user may lubricate the annular blade 216, for example, using one hand (i.e., the hand holding the knife handle). In addition, the grease cup assembly 204 being positioned nearer the knife handle results in the rotary knife being more compact and reduces the risk of the grease cup assembly 204 catching or snagging on other items, such as cables or hoses, proximate the rotary knife during use. Additionally, as described herein, the alternate mounting positions allow a user to selectively mount the grease cup assembly 204 for convenience and ease of access based on the user's preference and/or handedness.

In this alternative embodiment, mounting of the grease cup assembly 204 involves the mounting elbow 202 being received in one of the threaded counterbores defined in the mounting bosses, such mounting boss 212b. The mounting shaft portion 206 of the grease cup assembly 204 is received in a threaded counterbore defined in the mounting elbow 202. When the flexible membrane of the grease cup assembly 204 is pressed, a lubricant is channeled through the mounting shaft portion 206, through the mounting elbow 202, through a lubricant channel defined between the threaded counterbore defined in the mounting boss 212b and a groove of the blade housing 208, and directly to the lubrication interface zone defined between the annular blade and blade housing races, thereby providing lubrication to the annular blade 20.

Advantageously, the arrangement of features of the present invention facilitates directly lubricating the circumference of the annular blade at the blade/blade housing interface, reducing heat generated in the blade assembly, and reducing burning of the carcass debris. This, in turn, facilitates reducing vibrations generated in the blade during use. In addition, the features of the present invention facilitate removing or ejecting the carcass debris and used lubricant from the blade assembly, thereby reducing required maintenance, reducing cost, and increasing efficiency of the rotary knife. Furthermore, advantages of the present invention facilitate conveniently locating a lubricating device where a user can conveniently access the device during use of the rotary knife.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A rotary knife comprising:
a blade housing including a housing race; and
an annular blade including a blade race,
one of the housing race and the blade race defining a wear band, and the other of the housing race and the blade race defining an annular groove,
the annular groove receiving the wear band such that the annular blade is rotatably supported by the blade housing,
the wear band having an annular surface,
the wear band including a plurality of surface features formed in the annular surface.

2. The rotary knife in accordance with claim 1,
the annular blade defining a rotation axis,
the plurality of surface features including a plurality of notches, each of which extends at least in part in an axial direction.

3. The rotary knife in accordance with claim 2,
the plurality of notches being circumferentially equispaced about the annular surface of the wear band.

4. The rotary knife in accordance with claim 2,
each notch of the plurality of notches having an arcuate cross-sectional shape.

5. The rotary knife in accordance with claim 2,
a first notch of the plurality of notches having a first cross-sectional shape,
a second notch of the plurality of notches having a second cross-sectional shape different than the first cross-sectional shape.

6. The rotary knife in accordance with claim 2,
a first notch of the plurality of notches being circumferentially spaced a first distance from a second notch of the plurality of notches,
the second notch being circumferentially spaced a second distance from a third notch of the plurality of notches, the second distance being different than the first distance.

7. The rotary knife in accordance with claim 2,
the wear band comprising a radially projecting annular lip defining the annular surface and projecting a first radial distance.

8. The rotary knife in accordance with claim 7,
each of the notches extending at least in part in the axial direction through an entirety of the wear band.

9. The rotary knife in accordance with claim 8,
each of the notches extending radially from the annular surface the first radial distance.

10. The rotary knife in accordance with claim 8,
each of the notches extending radially from the annular surface a second radial distance different than the first radial distance.

11. The rotary knife in accordance with claim 8,
a first notch of the plurality of notches extending radially from the annular surface a first depth,
a second notch of the plurality of notches extending radially from the annular surface a second depth different than the first depth.

12. The rotary knife in accordance with claim 8,
each notch of the plurality of notches extending axially.

13. The rotary knife in accordance with claim 1,
the blade race defining the wear band,
the housing race defining the annular groove,
the plurality of surface features being circumferentially equispaced about the annular surface of the wear band.

14. The rotary knife in accordance with claim 13,
the plurality of surface features comprising thirty-six (36) individual surface features.

15. The rotary knife in accordance with claim 13,
the blade housing including a unitary split ring body that presents spaced-apart circumferential ring ends defining a housing gap therebetween,
the housing race extending continuously between the ring ends.

16. The rotary knife in accordance with claim 15, further comprising:
a knife head defining a drive axis,
a pinion gear supported by the knife head and rotatable about the drive axis, the annular blade defining a rotation axis, the rotation axis being perpendicular to the drive axis,
the pinion gear configured to rotate the annular blade about the rotation axis.

17. The rotary knife in accordance with claim 16,
the annular blade including a ring gear that intermeshes with the pinion gear so that rotation of the pinion gear imparts rotation to the annular blade.

18. The rotary knife in accordance with claim 16, further comprising:
a plurality of fasteners securing the blade housing to the knife head,
the blade housing being positionable between a blade-securing position wherein the annular blade is rotatably supported by the blade housing, and a blade-releasing position wherein the spaced-apart circumferential ring ends are moved apart and thereby enlarge the housing gap.

19. The rotary knife in accordance with claim 16,
the spaced-apart circumferential ring ends cooperatively presenting an arcuate relief,
the arcuate relief configured to receive a portion of the pinion gear.

20. The rotary knife in accordance with claim 1,
the annular groove having an inner surface,
the annular surface of the wear band being spaced from the inner surface of the annular groove, defining a lubrication interface zone therebetween,
the lubrication interface zone sized to receive a lubricant therein.
